(19) United States
(12) Patent Application Publication
(10) Pub. No.: US 2002/0057739 A1
(43) Pub. Date: May 16, 2002

(54) Method and apparatus for encoding video

(76) Inventors: Takumi Hasebe, Kyoto (JP); Takao Matsumoto, Osaka (JP); Aki Yoneda, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/978,656

(22) Filed: Oct. 18, 2001

(30) Foreign Application Priority Data
Oct. 19, 2000 (JP) 2000-319007

(51) Int. Cl. H04N 11/04; H04N 11/02; H04N 7/12; H04B 1/66

(52) U.S. Cl. 375/240.01

(57) ABSTRACT

The present invention has for its object to carry out encoding processes for video scene data in parallel and efficiently. The video scene data is divided by an input processing unit 21. In plural encoding units 3, encoding conditions for the divided video scene data are set to decode an end point of a divided video scene data and a start point of a following divided video scene data successively when these consecutive video scene data are connected with each other, and the data are encoded to create coded stream data. The coded stream data obtained from the plural encoding units 3 are connected with each other by an output processing unit 22.

### FIELD OF THE INVENTION

The present invention relates to a method and apparatus for compressively encoding video and, more particularly, to a compressive encoding method and apparatus including plural encoding units.

### BACKGROUND OF THE INVENTION

An MPEG system is commonly used as a system which performs encoding or decoding by employing a compression technology for moving picture data. The MPEG system is constructed by an encoder for converting certain information into another code and transmitting the converted code, and a decoder for restoring the code transmitted from the encoder to the original information. Structures of the prior art decoder and encoder are shown in FIGS. 16 and 17.

FIG. 16 is a diagram for explaining a structure of a prior art decoding apparatus.

I FIG. 16, a decoder controller 50 controls a decoder 52. A data buffer 51 temporarily stores inputted coded stream data 203. The decoder 52 receives coded stream data 201, and decodes the data to create video scene data 202. A frame buffer 53 temporarily stores the video scene data 202 decoded by the decoder 52.

The operation of the decoder apparatus constructed as described above will be described with reference to FIGS. 16 and 21.

FIGS. 21(a) and 21(b) are diagrams showing modeled acceptable amounts of coded stream data 203 which are stored in the data buffer 51 on the decoder side. FIG. 21(a) and 21(b) show coded stream data which are encoded by two encoders (encoding units), respectively.

Signal diagrams shown in FIGS. 21(a) and 21(b) state that after coded stream data is inputted at a transfer rate R, the data is reduced by the amount of compressed data equivalent to a frame to be decoded, at a timing when the data is inputted to the decoder 52.

MPEG stream data which is one of the coded stream data contains ID information of the stream, and a DTS (Decoding Time Stamp) corresponding to decoding start time information and a PTS (Presentation Time Stamp) corresponding to display start time information as its time information. Then, the time management is performed on the basis of the information and the decoding process is performed such that the data buffer 51 does not break down.

Initially, the decoder controller 50 receives coded stream data 200, checks that the data is a stream to be decoded by the decoder 52, obtains DTS and PTS information from the coded stream data 200, and outputs coded stream data 203 and transfer control information 204 which controls transfer of compressed data in the data buffer 51 for enabling the decoder 52 to start decoding on the basis of the DTS information, to the data buffer 51. The transfer rate at this time has a value equivalent to the inclination R shown in FIG. 21, and the decoder controller 50 outputs the coded stream data 203 to the data buffer 51 at the fixed rate.

Next, the data buffer 51 temporarily stores the inputted coded stream data 203, and outputs coded stream data 201 to the decoder 52 in accordance with the DTS.

The decoder 52 decodes the coded stream data 201 inputted from the data buffer 51 in frame units in accordance with decoding timing information 205 inputted from the decoder controller 50. Specifically, in the case of video of 30 Hz frame rate, the decoding process is carried out once every 1/30 sec. FIGS. 21 show cases where the decoding process is carried out ideally, and in these cases the coded stream data 203 inputted into the data buffer 51 at the transfer rate R is outputted instantly to the decoder 52 once every unit of time as the coded stream data 201. When the coded stream data 201 is outputted to the decoder 52, the coded stream data 203 is supplied from the decoder controller 50 to the data buffer 51 still at the transfer rate R. Subsequently, video scene data 202 decoded by the decoder 52 is temporarily stored in the frame buffer 53.

In the MPEG stream data, the order in which frames are decoded is sometimes different from the order in which frames are displayed, and thus the frames are sorted in the frame buffer 53 in the display order. The video scene data 202 inputted to the frame buffer 53 is outputted to the decoder controller 50 as video scene data 207 in accordance with display start control information 206 on the basis of the PTS information inputted from the decoder controller 50. Then, the video scene data 207 inputted to the decoder controller 50 is outputted as a display output signal 208, and inputted to a display device or the like.

Next, the prior art encoding apparatus will be described.

FIG. 17 is a diagram for explaining a structure of a prior art encoding apparatus.

In FIG. 17, an encoder controller 54 controls an encoder 56. A frame buffer 55 temporarily stores inputted video scene data 212. The encoder 56 receives video scene data 210, and encodes the data to create coded stream data 211. A data buffer 57 temporarily stores the coded stream data 211 which is encoded by the encoder 56.

The operation of the encoding apparatus constructed as described above will be described.

Initially, the encoder controller 54 receives video scene data 209, checks that the data is video scene data to be encoded by the encoder 56, and thereafter outputs video scene data 212 to the frame buffer 55 as well as outputs encoding start control information 213 as information for controlling the start of encoding. The encoding start control information 213 decides the order of video scene data to be encoded, and controls the transfer order of the video scene data so as to output the video scene data 210 from the frame buffer 55 to the encoder 56 according to the decided order. Usually, the transfer order of the video scene data can be decided according to frame types of a GOP structure shown in FIG. 19 (which will be described later). The encoder controller 54 further outputs encoding control information 214 including the transfer order of the video scene data, encoding conditions and the like, to the encoder 56. This encoding control information 214 includes information about the GOP structure, a quantization value, such as a quantization matrix and a quantization scale, for quantizing coefficients of respective video scene data which have been subjected to a DCT process, and the like.

The encoder 56 encodes the video scene data 210 inputted from the frame buffer 55 in accordance with the encoding control information 214, generates coded stream data 211, and outputs the coded stream data 211 to the data buffer 57.

The data buffer 57 temporarily stores the inputted coded stream data 211, and outputs coded stream data 216 to the encoder controller 54 in accordance with transfer control information 215 of the coded stream data, which is inputted from the encoder controller 54.

At this time, when the coded stream data 217 is outputted to the decoding apparatus, the encoder controller 54 performs simulation as to whether an underflow occurs in the data buffer 51. The buffer underflow will be described later. As a result of the simulation, when no buffer underflow occurs, the encoder controller 54 outputs the coded stream data 217. However, when the buffer underflow occurs, the encoder controller 54 outputs the encoding control information 214 to the encoder 56 so as to suppress the amount of the coded stream data 211, thereby setting the amount of codes. Here, the setting of the code amount means for example that the quantization value is changed, the generation of the coded stream data 211 is suppressed, and then the encoding process is carried out again.

Next, a method for setting a target code amount so as not to cause the buffer underflow will be described in detail.

Initially, in order to carry out an encoding process of a high image quality, there is a method for performing a two-pass encoding.

To be more specific, information for obtaining encoding conditions to perform the encoding of a high image quality is obtained at a first encoding, and final coded stream data is obtained at a second encoding.

Initially, in the first encoding process, the encoding process is carried out with fixing the quantization value. When the quantization value is fixed, quantization distortions as results of the encoding processes for respective frames can be made almost equal. That is, image qualities which are obtained when the coded stream data are decoded can be equalized. However, in the process of fixing the quantization value, it cannot be ensured that no underflow occurs in the data buffer 51 at the decoding. Further, it is impossible to accurately control the amount of coded stream data. Thus, at the first encoding, the amount of the coded stream data for each frame in the case where the quantization value is fixed is observed. Then, at the second encoding, on the basis of the observed information, the trial calculation of the target code amount for each frame is performed so as to prevent the buffer underflow. Then, a quantization value assuming the calculated target code amount is set as the encoding control information 214.

Next, a method for obtaining the final coded stream data by one pass will be described.

The target code amount which is set as the first encoding control information 214 is the amount of data by which no buffer underflow is caused. In order to limit the data to that amount, the encoding control information 214 is changed halfway through the encoding process for one frame to suppress the generation of the coded stream data 211, thereby controlling the data within the target code amount. To be more specific, the encoding control information 214 is set in the encoder 56 such that the amount of coded stream data is decided as the target code amount of that frame, so as to have a value which causes no buffer underflow. Then, at a time when the encoding of the video scene data 210 is to be started, the quantization value as the target code amount is set by the encoding controller 54 and then the encoding process is started. When the process for half of the frame is ended, the amount of encoded data outputted to the data buffer 57 is checked by the encoder controller 54. The amount of encoded data obtained when the whole frame is encoded is estimated from the checked amount of encoded data. When the estimated amount of encoded data exceeds the target code amount, the quantization value to be set is changed for the encoder 56 so as to decrease generated encoded data. When the estimated amount does not reach the target code amount, the quantization value to be set is changed so as to increase the generated encoded data.

When the above-mentioned control method is performed in the middle of the encoding process, the set target code amount can be realized and consequently the amount of coded stream data which causes no buffer underflow can be obtained.

An encoding method according to the MPEG system is a typical method for compressively encoding video. The MPEG system is a system that uses a Discrete Cosine Transformation (hereinafter, referred to as DCT), a motion estimation (hereinafter, referred to as ME) technology and the like. Especially in the ME technology part, improvement in the accuracy of motion vector detection is a factor that increases the image quality, and the amount of its operation is quite large.

In the prior art compressive encoding method or apparatus, since the operation amount in the ME part is large, the compressive encoding method or apparatus is usually constituted by hardware in many cases. However, recently, MPEG encoding products which are implemented by software are also available. Hereinafter, an example of a prior art compressive encoding tool which is constituted by software will be described with reference to figures.

FIG. 18 is a block diagram for explaining a structure of a prior art encoder.

The MPEG encoding method is a standard compressive encoding method for moving pictures, and there are internationally standardized encoding methods called MPEG1, MPEG2 and MPEG4. FIG. 18 is a block diagram for implementing an encoder according to MPEG1 and MPEG2.

In FIG. 18, the DCT and the ME technology are used as the main technologies. The ME is a method for predicting a motion vector between frames, and forward prediction which refers to temporally forward video data, backward prediction which refers to temporally backward video data or bidirectional prediction which uses both of these data is employed.

FIG. 19 is a diagram for explaining the encoding picture types in the MPEG encoding process.

In FIG. 19, alphabets in the lower portion show types of respective pictures to be encoded. “I”, designates a picture that is intra-picture coded. “P” designates a picture that is coded by performing the forward prediction. “B” designates a picture that is coded by performing the bidirectional prediction, i.e., both of the forward and backward predictions.

In FIG. 19, pictures are shown from the top in the order in which video scene data are inputted. Arrows in the figure show directions of the prediction. Further, numbers inside parentheses show the order in which encoding is performed. To be more specific, I(1) denotes a picture that is intra-picture coded, and P(2) denotes a picture that is encoded next and encoded by performing the forward prediction with using I(1) as a reference picture. Thereafter, pictures between I(1) picture and P(2) picture, i.e., B(3) and B(4) are encoded as B pictures which are subjected to the bidirectional prediction, with using the I and P pictures as reference pictures. Next, units of a frame which are subjected to the motion estimation will be shown in FIG. 20.

FIG. 20 is a diagram for explaining the units of a frame which are subjected to the motion estimation.

As shown in FIG. 20, the motion estimation and encoding process is carried out in units, which unit is called macroblock being composed of 16 pixels×16 pixels of luminance information. In the case of encoding I pictures, there are only intra-macroblocks. In the case of encoding P pictures, the coding type can be selected between the intra-macroblock and the forward prediction. In the case of B pictures, the coding type can be selected from the intra-macroblock, the forward prediction and the bidirectional prediction.

Hereinafter, the operation of the encoding process will be described with reference to FIG. 18.

Initially, the video scene data 210 inputted to the encoder 56 is subjected to the motion estimation in macroblock units in a motion estimation unit 60 on the basis of each picture type, with reference to inputted data of each picture type, as described with referring to FIG. 19. Further, the motion estimation unit 60 outputs coding type information 220 for each macroblock and motion vector information 221 according to the coding type, while macroblock data to be encoded is passed through an adder 61. In the case of I picture, no operation such as addition is performed, and a DCT process is carried out in a DCT unit 62. The data which has been subjected to the DCT process is quantized by a quantization unit 63. Then, in order to efficiently encode the quantized data, a variable-length coding process is performed in a variable-length coding unit (hereinafter, referred to as VLC unit) 64. The coded data which has been coded by the VLC unit 64 are multiplexed in a multiplexing unit 65 with the coding type information 220 and the motion vector information 221 which is outputted from the motion estimation unit 60, and multiplexed coded stream data 211 is outputted.

The data which has been quantized by the quantization unit 63 is subjected to the variable-length coding process in the VLC unit 64 while it is outputted to an inverse quantization unit 66 and subjected to an inverse quantization process. Then, the data is subjected to an inverse DCT process in an inverse DCT unit 67 and decoded video scene data is generated. The decoded video scene data is temporarily stored in a picture storage memory 69, and utilized as reference data at the prediction in the encoding process for P pictures or B pictures. For example, when inputted video is a P picture, the motion estimation unit 60 detects the motion vector information 221 corresponding to its macroblock, as well as decides the coding type information 220 of the macroblock, for example the forward prediction coding type. A motion prediction unit 70 uses the decoded data stored in the picture storage memory 69 as the reference image data and obtains reference data according to the coding type information 220 and the motion vector information 221 which is obtained by the motion estimation unit 60, and an adder 61 obtains differential data corresponding to the forward prediction type. The differential data is subjected to the DCT process in the DCT unit 62, and thereafter quantized by the quantization unit 63. The quantized data is subjected to the variable-length coding process in the VLC unit 64 while it is inversely quantized by the inverse quantization unit 66. Thereafter, the similar processes are repeatedly performed.

However, in the above-mentioned prior art video encoding method and apparatus, when video scene data is divided and encoded and thereafter coded stream data are connected with each other, the buffer underflow occurs. Hereinafter, the buffer underflow will be described in detail.

FIGS. 21(a) and 21(b) are diagrams each showing a modeled acceptable amount of coded stream data which is stored in the data buffer on the decoder side.

In FIG. 21, “VBV-max” indicates the maximum value of the acceptable amount of data in the buffer. “R” denotes an ideal transfer rate, which is a data transfer rate at which coded stream data is received at the decoding by the data buffer.

In FIGS. 21, each signal diagram shows that the coded stream data is inputted to the data buffer at a fixed transfer rate R at the decoding and, at an instant at which each picture is decoded, coded stream data of the amount of data which have been decoded are outputted from the data buffer. At the encoding, when the outputting of data and the decoding is repeatedly performed as described above, the buffer simulation at the encoding is performed according to MPEG standards. In the MPEG encoding process, it is required that the underflow of the data buffer at the decoding should be avoided. To be more specific, when the underflow occurs in the data buffer, the encoding process is adversely interrupted, whereby reproduction of video is disturbed at the decoding. Thus, the encoder controller 54 shown in FIG. 17 performs control for preventing the buffer underflow. The encoder controller 54 simulates the state of the data buffer 51 at the decoding and outputs the encoding control information 214 to the encoder 56 so as to prevent the buffer underflow. For example when it is judged that there is a higher risk of the underflow of the data buffer 51, the controller 54 outputs the encoding control information 214 to the quantization unit 63 so as to perform such a quantization process that no coded stream data 211 is generated.

Next, FIG. 22 shows a case where the coded stream data which are obtained by two encoding apparatuses shown in FIGS. 21 are successively reproduced.

FIG. 22 is a diagram showing modeled acceptable amount of data in a case where the coded stream data in FIGS. 21(a) and 21(b) are connected with each other.

In FIG. 22, when the coded stream data shown in FIG. 21(b) is connected after the coded stream data shown in FIG. 21(a), the first picture FB-(1) in FIG. 21(b) is connected after the last picture FA-(na) in FIG. 21(a), and then it can be seen that the buffer underflow occurs in the picture FB-(1) (dotted line part in the figure). As described above, when video scene data is simply divided and respective coded stream data obtained by the encoding are connected with each other, the result of the connection may cause the underflow of the buffer.

Further, in this MPEG encoding process, particularly the ME process requires a considerable operation amount and it is commonly implemented by hardware. When this process is to be implemented by software, it is common that coding target video scene data is stored for a while and then the process is carried out with reading the data. Further, in order to carry out the process at a speed as high as possible, the encoding apparatus should be constructed so as to perform the processing in parallel.

FIG. 23 is a diagram for explaining a structure for a parallel processing in the prior art encoding apparatus. In FIG. 23, a case where this encoding apparatus is provided with two encoding units is illustrated as an example.

In FIG. 23, an input processing unit 80 receives video scene data 209 to be encoded, then inputs the video scene data 209 to a data storage unit 83 to be temporarily stored therein, as well as divides the video scene data 209. Then, the input processing unit 80 transmits divided video scene data 210 and transfer control information indicating which video scene data is outputted to which encoding unit, to a first encoding unit 81 and a second encoding unit 82. The encoding units 81 and 82 carry out the encoding processes with accessing the video scene data stored in the data storage unit 83, create coded stream data 211a and 211b, and output the data to an output processing unit 84, respectively. The output processing unit 84 connects the coded stream data 211a and 211b which are inputted from the encoding units 81 and 82, respectively, create continuous coded stream data 217, and outputs the data.

However, in the encoding apparatus constructed as described above, the plural encoding units 81 and 82 should perform the processes with accessing one data storage unit 83. At this time, in the MPEG encoding process as shown in FIG. 22, it is required to perform control for preventing the state of the buffer at the decoding from underflowing. Fundamentally, when coded stream data which can be continuously reproduced are to be created, the encoding processes should be carried out continuously without dividing video stream data. Otherwise, as shown in FIG. 22, the buffer underflow and the like may occur. As described above, even when the video scene data is simply divided and subjected to the encoding process, and coded stream data which have been subjected to the encoding process are connected in parallel, the data may not be reproduced normally and continuously.

Hereinafter, an encoding method for preventing the buffer underflow will be examined.

Initially, one solution lies in performing the encoding process for video scene data in accordance with time series at the reproduction. However, in this case, it is difficult to improve efficiency, such as to reduce the processing time.

Secondly, when spatial processing is performed in parallel, the processes for detecting the motion vector information can be performed in parallel in macroblock units. However, ranges in which motion vector information of different macroblocks in one frame is detected may overlap, and in this case the same reference data or video data become the processing targets. For example, in the first encoding unit 81 and the second encoding unit 82 in FIG. 23, the motion vector information of macroblocks can be generated in parallel, respectively. However, in FIG. 23, since one data storage unit 83 is included, the same video scene data 209 is handled, and the encoding units 81 and 82 may simultaneously access the same data storage unit 83. That is, the transfer rate for the data storage unit 83 is restricted, and it is impossible to perform more parallel processings to increase the degree of the parallel processing.

### SUMMARY OF THE INVENTION

The present invention has for its object to provide a video encoding method and apparatus which can increase the degree of parallelism and efficiently perform compressive encoding, when a compressive encoding process according to the MPEG encoding method is carried out in parallel, more particularly when the encoding process is carried out based on software.

Other objects and advantages of the present invention will become apparent from the detailed description and specific embodiments described are provided only for illustration since various additions and modifications within the spirit and scope of the invention will be apparent to those of skill in the art from the detailed description.

According to a 1st aspect of the present invention, there is provided a video encoding method for carrying out an encoding process in a video encoding apparatus having plural encoding units comprising steps of: dividing video scene data into plural pieces; setting encoding conditions for the divided video scene data to decode an end point of a divided video scene and a start point of a following divided video scene data successively when these consecutive video scene data are connected with each other; inputting the divided video scene data into the plural encoding units and creating coded stream data; and connecting the coded stream data obtained from the plural encoding units with each other.

According to a 2nd aspect of the present invention, in the video encoding method of the 1 aspect, the setting of the encoding conditions includes at least: setting of a closed GOP, which is performed for the start point of the divided video scene data; and setting of a target amount of codes, which is performed for the encoding units, such that an amount of data occupying a buffer memory has a predetermined value when the coded stream data are successively decoded.

According to a 3rd aspect of the present invention, there is provided a video encoding method for carrying out an encoding process in a video encoding apparatus having plural encoding units comprising steps of: making parts of video scene data overlap and dividing the video scene data; detecting scene change points of the divided video scene data; setting encoding conditions for the divided video scene data to decode the scene change points of consecutive video scene data successively when these consecutive video scene data are connected with each other; inputting the divided video scene data into the plural encoding units and creating coded stream data; and connecting the coded stream data obtained from the plural encoding units with each other.

According to a 4th aspect of the present invention, in the video encoding method of the 3rd aspect, the setting of the encoding conditions include at least: setting of a closed GOP, which is performed for a start point of the divided video scene data; and setting of a target amount of codes, which is performed for the encoding units, such that an amount of data occupying a buffer memory has a predetermined value when the coded stream data are successively decoded.

According to a 5th aspect of the present invention, there is provided a video encoding method for carrying out an encoding process in a video encoding apparatus having plural encoding units comprising steps of: detecting scene change points of video scene data; dividing the video scene data at the scene change points; setting encoding conditions for the divided video scene data to decode an end point of a divided video scene data and a start point of a following divided video scene data successively when these consecutive video scene data are connected with each other; inputting the divided video scene data into the plural encoding units and creating coded stream data; and connecting the coded stream data obtained from the plural encoding units with each other.

According to a 6th aspect of the present invention, in the video encoding method of the 5th aspect, the setting of the encoding conditions includes at least: setting of a closed GOP, which is performed to the start point of the divided video scene data; and setting of a target amount of codes, which is performed for the encoding units, such that an amount of data occupying a buffer memory has a predetermined value when the coded stream data are successively decoded.

According to a 7th aspect of the present invention, there is provided a video encoding method for carrying out an encoding process in a video encoding apparatus having plural encoding units comprising steps of: detecting scene change points of video scene data; detecting motion information in the video scene data; dividing the video scene data so that amounts of operations in the plural encoding units are nearly equalized; setting encoding conditions for the divided video scene data to decode an end point of a divided video scene data and a start point of a following divided video scene data successively when these consecutive video scene data are connected with each other; inputting the divided video scene data into the plural encoding units and creating coded stream data; and connecting the coded stream data obtained from the plural encoding units with each other.

According to an 8th aspect of the present invention, in the video encoding method of the 7th aspect, the setting of the encoding conditions include at least: setting of a closed GOP, which is performed for the start point of the divided video scene data; and setting of a target amount of codes, which is performed for the encoding units, such that an amount of data occupying a buffer memory has a predetermined value when the coded stream data are successively decoded.

According to a 9th aspect of the present invention, in the video encoding method of the 7th aspect, the division of the video scene data is performed so as to nearly equalize detection ranges of motion vectors for encoding the video scene data.

According to a 10th aspect of the present invention, there is provided a video encoding method for carrying out an encoding process by plural encoding systems comprising steps of: carrying out an encoding process by a first encoding system; and carrying out an encoding process by a second encoding system with using an encoding result obtained by the first encoding system.

According to an 11th aspect of the present invention, in the video encoding method of the 10th aspect, the encoding result obtained by the first encoding system is motion vector detection information.

According to a 12th aspect of the present invention, in the video encoding method of the 10th aspect, the first encoding system is an MPEG2 or MPEG4 system, and the second encoding system is an MPEG4 or MPEG2 system.

According to a 13th aspect of the present invention, there is provided a video encoding apparatus having plural encoding units comprising: a division unit for dividing video scene data; an encoding condition setting unit for setting encoding conditions for the divided video scene data to decode an end point of a divided video scene data and a start point of a following divided video scene data successively when these consecutive video scene data are connected with each other; plural encoding units for encoding the divided video scene data to create coded stream data; and a connection unit for connecting the coded stream data obtained from the plural encoding units with each other.

According to a 14th aspect of the present invention, in the video encoding apparatus of the 13th aspect, the encoding condition setting unit performs at least: setting of a closed GOP, which is performed for the start point of the divided video scene data; and setting of a target amount of codes, which is performed for the encoding units, such that an amount of data occupying a buffer memory has a predetermined value when the coded stream data are successively decoded.

According to a 15th aspect of the present invention, there is provided a video encoding apparatus having plural encoding units comprising: a division unit for making parts of video scene data overlap and dividing the video scene data; a scene change point detection unit for detecting scene change points of the divided video scene data; an encoding condition setting unit for setting encoding conditions for the divided video scene data to decode the scene change points of consecutive video scene data successively when these consecutive video scene data are connected with each other; plural encoding units for encoding the divided video scene data to create coded stream data; and a connection unit for connecting the coded stream data obtained from the plural encoding units with each other.

According to a 16th aspect of the present invention, in the video encoding apparatus of the 15th aspect, the encoding condition setting unit performs at least: setting of a closed GOP, which is performed for a start point of the divided video scene data; and setting of a target amount of codes, which is performed for the encoding units, such that an amount of data occupying a buffer memory has a predetermined value when the coded stream data are successively decoded.

According to a 17th aspect of the present invention, there is provided a video encoding apparatus having plural encoding units comprising: a scene change detection unit for detecting scene change points of video scene data; a division unit for dividing the video scene data at the scene change points; an encoding condition setting unit for setting encoding conditions for the divided video scene data to decode an end point of a divided video scene data and a start point of a following divided video scene data successively when these consecutive video scene data are connected with each other; plural encoding units for encoding the divided video scene data to create coded stream data; and a connection unit for connecting the coded stream data obtained from the plural encoding units with each other.

According to an 18th aspect of the present invention, in the video encoding apparatus of the 17th aspect, the encoding condition setting unit performs at least: setting of a closed GOP, which is performed for the start point of the divided video scene data; and setting of a target amount of codes, which is performed for the encoding units, such that an amount of data occupying a buffer memory has a predetermined value when the coded stream data are successively decoded.

According to a 19th aspect of the present invention, there is provided a video encoding apparatus having plural encoding units comprising: a scene change point detection unit for detecting scene change points of video scene data; a motion information detection unit for detecting motion information in the video scene data; a division unit for dividing the video scene data so that amounts of operations in the plural encoding units are nearly equalized; an encoding condition setting unit for setting encoding conditions for the divided video scene data to decode an end point of a divided video scene data and a start point of a following divided video scene data successively when these consecutive video scene data are connected with each other; plural encoding units for encoding the divided video scene data to create coded stream data; and a connection unit for connecting the coded stream data obtained from the plural encoding units with each other.

According to a 20th aspect of the present invention, in the video encoding apparatus of the 19th aspect, the encoding condition setting unit performs at least: setting of a closed GOP, which is performed for the start point of the divided video scene data; and setting of a target amount of code, which is performed for the encoding units, such that an amount of data occupying a buffer memory has a predetermined value when the coded stream data are successively decoded.

According to a 21st aspect of the present invention, in the video encoding apparatus of the 19th aspect, the division unit divides the video scene data such that detection ranges of motion vectors for encoding the video scene data are nearly equalized.

According to a 22nd aspect of the present invention, there is provided a video encoding apparatus for carrying out an encoding process by plural encoding systems comprising: a first encoding unit for carrying out an encoding process by a first encoding system; and a second encoding unit for carrying out an encoding process by a second encoding system with using an encoding result obtained by the first encoding system.

According to a 23rd aspect of the present invention, in the video encoding apparatus of the 22nd aspect, the result obtained by the first encoding system is motion vector detection information.

According to a 24th aspect of the present invention, in the video encoding apparatus of the 22nd aspect, the first encoding unit uses an MPEG2 or MPEG4 system, and the second encoding unit uses an MEPG4 or MPEG2 system.

According to the video encoding method and apparatus of the present invention, video scene data is divided, and thereafter setting of the closed GOP and setting of the target code amount is performed as the setting of encoding conditions, and then the encoding process is carried out. Therefore, an efficient encoding process can be carried out.

According to the video encoding method and apparatus of the present invention, plural encoding units are included and the encoding processes are performed in parallel. Therefore, the number of parallel processings in the encoding process can be easily increased and a flexible system structure can be constructed.

### BRIEF DESCRIPTION OF THE DRAWINGS

FIG. 1 is a diagram for explaining a structure of an encoding apparatus according to a first embodiment of the present invention.

FIG. 2 is a diagram for explaining a structure for a parallel processing in the encoding apparatus of the first embodiment.

FIG. 3 is a block diagram for explaining a structure of an encoding unit in FIG. 2.

FIG. 4 is a flowchart for explaining an operation of an encoding process according to the first embodiment.

FIGS. 5(a) and 5(b) are diagrams each showing a modeled acceptable amount of coded stream data which are stored in a data buffer on a decoder side according to embodiments of the present invention.

FIG. 6 is a diagram showing a case where two pieces of coded stream data in FIGS. 5(a) and 5(b) are connected with each other.

FIG. 7 is a block diagram for explaining details of an output processing unit 22 in FIG. 2.

FIG. 8 is a block diagram for explaining details of an input processing unit according to a second embodiment of the present invention.

FIG. 9 is a block diagram for explaining details of an encoding unit according to the second embodiment.

FIG. 10 is a flowchart for explaining an operation of an encoding process according to the second embodiment.

FIG. 11 is a block diagram for explaining details of an input processing unit according to a third embodiment of the present invention.

FIG. 12 is a flowchart for explaining an operation of an encoding process according to the third embodiment.

FIG. 13 is a block diagram for explaining details of an input processing unit according to a fourth embodiment of the present invention.

FIG. 14 is a flowchart for explaining an operation of an encoding process according to the fourth embodiment.

FIG. 15 is a flowchart for explaining an operation of an encoding process, which is performed with using plural encoding methods, according to a fifth embodiment of the present invention.

FIG. 16 is a diagram for explaining a structure of a prior art decoding apparatus.

FIG. 17 is a diagram for explaining a structure of a prior art encoding apparatus.

FIG. 18 is a block diagram for explaining a structure of a prior art encoder.

FIG. 19 is a diagram for explaining encoding picture types of an MPEG encoding process.

FIG. 20 is a diagram for explaining units of a frame, which are subjected to motion estimation.

FIGS. 21(a) and 21(b) are diagram each showing a modeled acceptable amount of coded stream data which are stored in a data buffer on a decoder side.

FIG. 22 is a diagram showing a modeled acceptable amount of data when the coded stream data in FIGS. 21(a) and 21(b) are connected with each other.

FIG. 23 is a diagram for explaining a structure for a parallel processing in the prior art encoding apparatus.

### DETAILED DESCRIPTION OF THE PREFERRED EMBODIMENTS

Hereinafter, embodiments of the present invention will be described.

[Embodiment 1]

A video encoding method and apparatus according to a first embodiment of the present invention divides video scene data, thereafter sets the encoding conditions, and then carries out the encoding process.

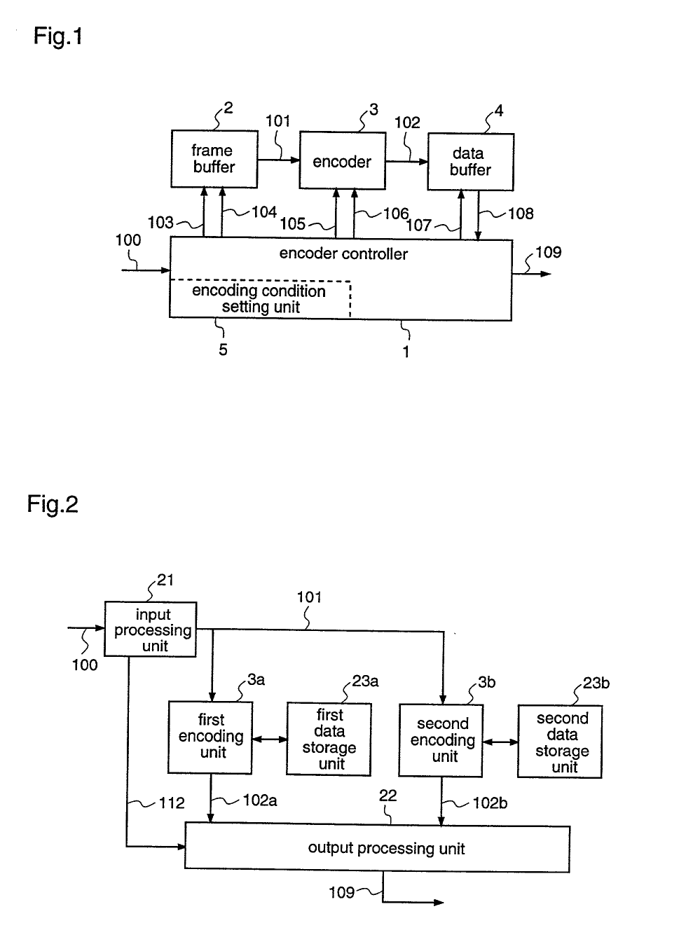

FIG. 1 is a diagram for explaining a structure of an encoding apparatus according to the first embodiment.

As shown in FIG. 1, an encoder controller 1 includes an encoding condition setting unit 5 for setting encoding conditions in an encoder 3, to control the encoder 3. A frame buffer 2 temporarily stores inputted video scene data 103. The encoder 3 receives video scene data 101, and carries out the encoding process to create coded stream data 102. A data buffer 4 temporarily stores the coded stream data 102 which has been subjected to the encoding process by the encoder 3.

The operation of the encoding apparatus constructed as described above will be described.

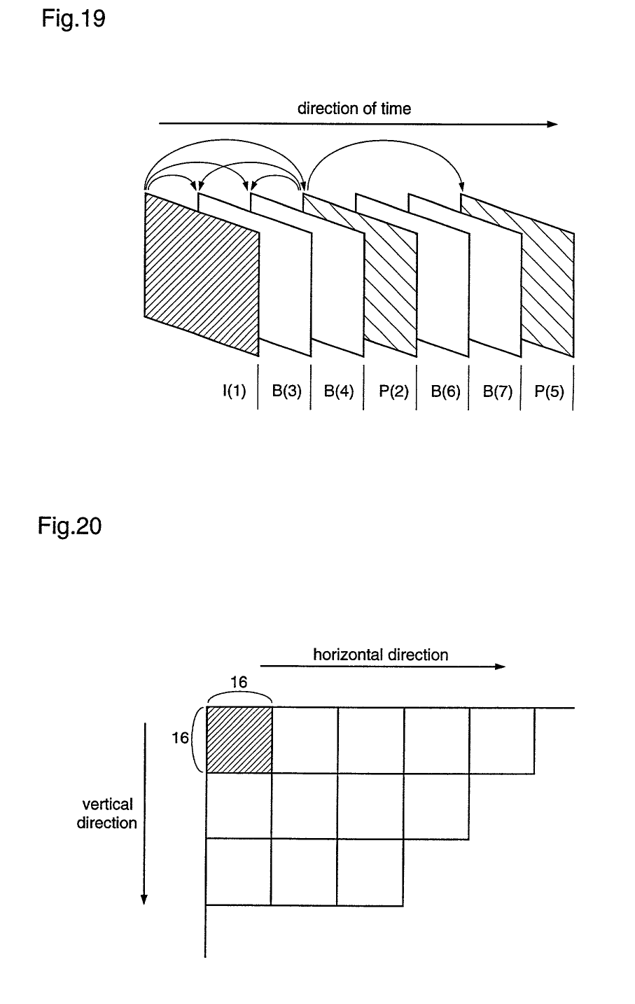

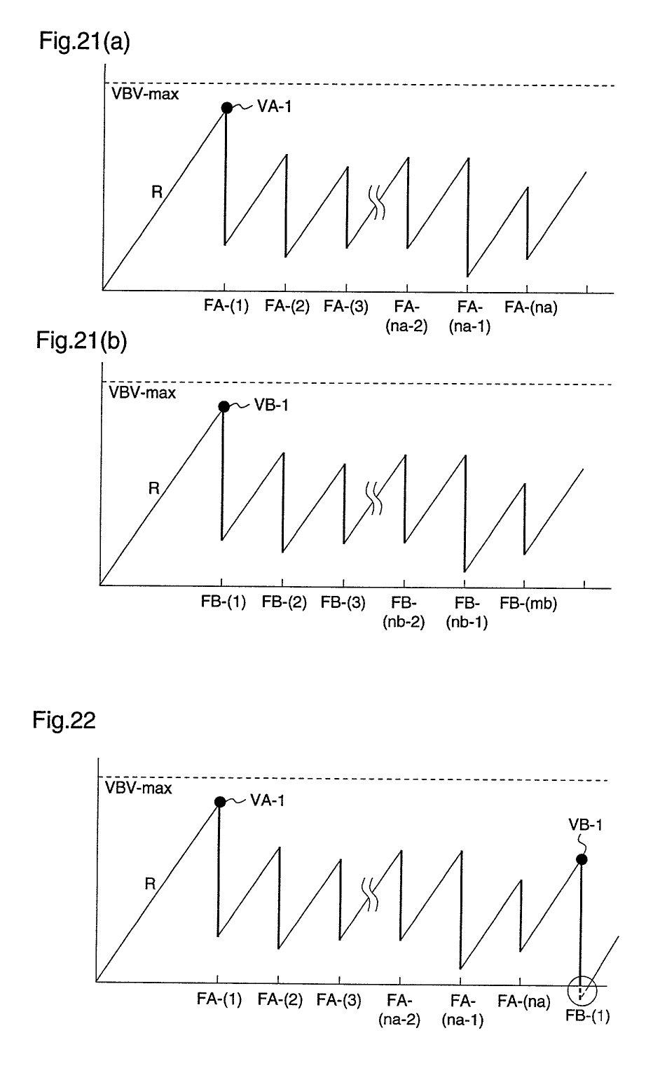

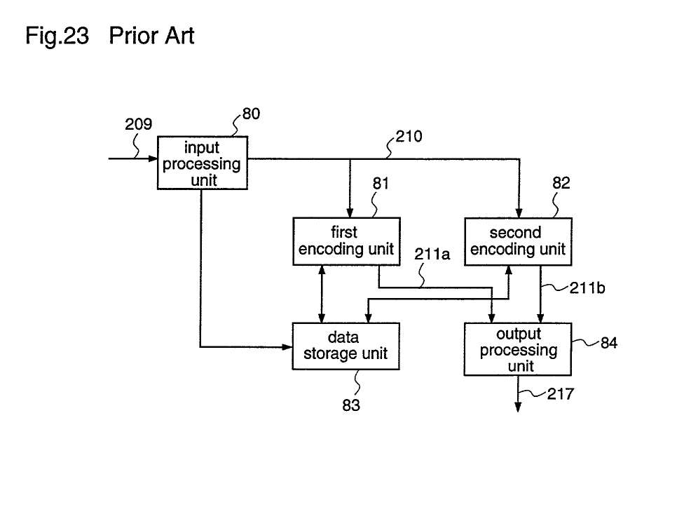

Initially, the encoder controller 1 receives video scene data 100, checks that the data is video scene data which is to be encoded by the encoder 3, and thereafter outputs video scene data 103 to the frame buffer 2 as well as outputs encoding start control information 104 as information for controlling the start of encoding to the frame buffer 2. The encoding start control information 104 decides the order of video scene data to be encoded, and controls the transfer order of the video scene data for outputting the video scene data 101 from the frame buffer 2 to the encoder 3 in the decided order. Usually, the transfer order of the video scene data can be decided according to respective frame types of a GOP structure as shown in FIG. 19. Further, the encoder controller 1 outputs encoding parameter information 105 indicating a structure of data to be encoded such as GOP structure data, including setting of a closed GOP, and quantization information 106 controlling the amount of generated codes, including a quantization matrix and a quantization scale and the like, to the encoder 3.

The encoder 3 encodes the video scene data 101 inputted from the frame buffer 2 in accordance with the encoding parameter information 105 and the quantization information 106, creates coded stream data 102, and outputs the data to the data buffer 4.

The data buffer 4 temporarily stores the inputted coded stream data 102, and outputs coded stream data 108 to the encoder controller 1 in accordance with transfer control data 107 of the coded stream data, which is inputted from the encoder controller 1.

At this time, the encoder controller 1 performs simulation as to whether the data buffer underflows or not when coded stream data 109 is outputted to a decoding apparatus. When it is confirmed that no buffer underflow occurs, the encoder controller 1 outputs the coded stream data 109. On the other hand, when the buffer underflow occurs, the controller 1 outputs the quantization information 106 to the encoder 3, thereby suppressing generation of the coded stream data 102, and carries out the encoding process again.

FIG. 2 is a diagram for explaining a structure for a parallel processing in the encoding apparatus according to the first embodiment. In FIG. 2, a case where the encoding apparatus is provided with two encoding units is shown as an example.

In FIG. 2, an input processing unit 21 receives video scene data 100 to be encoded, divides the data, and outputs divided video scene data 101 to a first encoding unit 3a and a second encoding unit 3b, respectively, as well as outputs transfer control information 112 to an output processing unit 22. The encoding units 3a and 3b temporarily store the inputted divided video scene data 101 in data storage units 23a and 23b, carry out the encoding process with reading the data to create coded stream data 102a and 102b, and output the data to the output processing unit 22, respectively. The output processing unit 22 connects the coded stream data 102a and 102b inputted from the encoding units 3a and 3b, respectively, on the basis of the transfer control information 112, and creates continuous coded stream data 109.

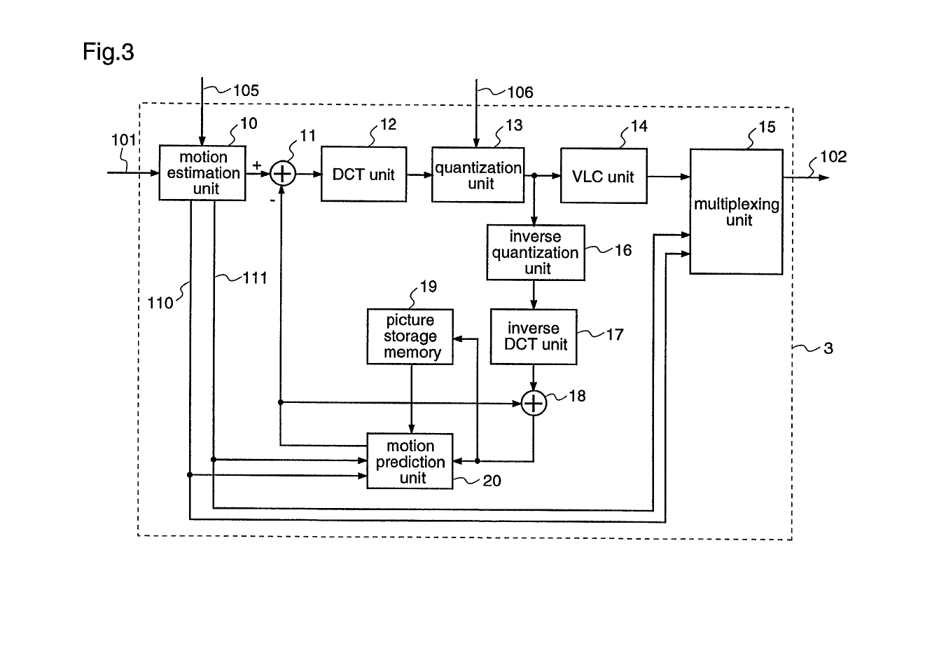

A block diagram of FIG. 3 shows the structure of the first encoding unit 3a and the second encoding unit 3b in more detail. FIG. 2 shows two encoding units (the first encoding unit 3a and the second encoding unit 3b), while both of the encoding units are composed of the same elements.

Initially, as shown in FIG. 3, in the encoding unit 3, the divided video scene data 101 outputted from the input processing unit 21 is inputted into a motion estimation unit 10, each picture data is referred to, and motion is estimated in macroblock units on the basis of the picture type. Then, the motion estimation unit 10 outputs coding type information 110 for each macroblock and motion vector information 111 according to the coding type. The macroblock data to be encoded passes through an adder 11. In the case of I picture, no operation is performed in the adder 11, and a DCT process is carried out in the next DCT unit 12. The data which has been subjected to the DCT process in the DCT unit 12 is quantized by a quantization unit 13. The data which has been quantized by the quantization unit 13 is subjected to a variable-length coding process in a variable-length coding unit (hereinafter, referred to as a VLC unit) 14 to encode the data efficiently. The coded data which has been coded by the VLC unit 14, and the coding type information 110 and motion vector information 111 which has been outputted from the motion estimation unit 10 and inputted to a multiplexing unit 15 are multiplexed with each other to create coded stream data 102, and the coded stream data 102 is outputted to the output processing unit 22.

The data quantized by the quantization unit 13 is subjected to the variable-length coding process in the VLC unit 14, while being subjected to an inverse quantization process in an inverse quantization unit 16. Then, an inverse DCT process is carried out in an inverse DCT unit 17, and decoded video scene data is outputted. The decoded video scene data is temporarily stored in a picture storage memory 19, and utilized as reference data at the time of prediction in the encoding process for P or B pictures. For example, when inputted video is a P picture, the motion estimation unit 10 detects the motion vector information 111 corresponding to that macroblock, as well as decides the coding type information 110 of the macroblock, for example a forward predictive coding type. A motion prediction unit 20 employs the decoded data stored in the picture storage memory 19 as reference image data and obtains reference data on the basis of the coding type information 110 and the motion vector information 111 which are obtained from the motion estimation unit 10, and the adder 11 obtains differential data corresponding to the forward predictive coding type. The differential data is subjected to the DCT process in the DCT unit 12, and thereafter quantized by the quantization unit 13. The quantized data is subjected to the variable-length coding process in the VLC unit 14 while being subjected to the inverse quantization process in the inverse quantization unit 16. Thereafter, the same processes are repeatedly performed.

This encoding process is carried out according to the respective coding type information and motion vector information. Further, in the MPEG encoding process, the process of encoding data taking a point that is supposed to be a scene change as a GOP boundary is frequently applied as an encoding technology of high image quality.

Hereinafter, the operation of the encoding unit will be described with reference to FIGS. 3, 4 and 7.

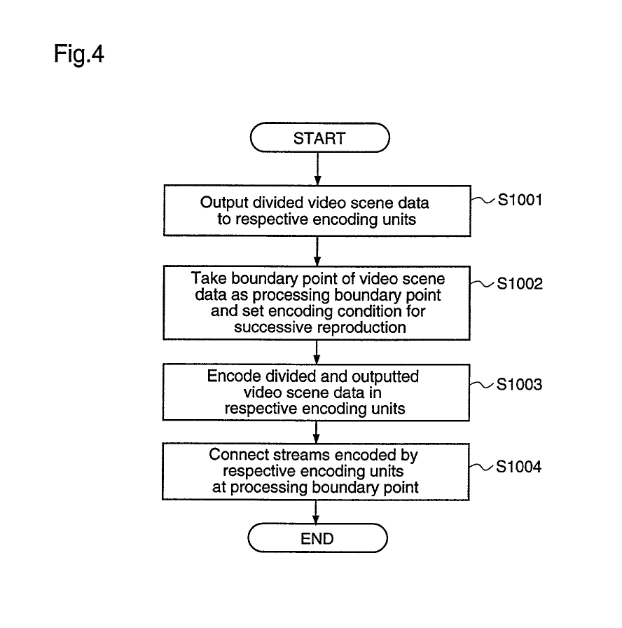

FIG. 4 is a flowchart for explaining the operation of the encoding process according to the first embodiment.

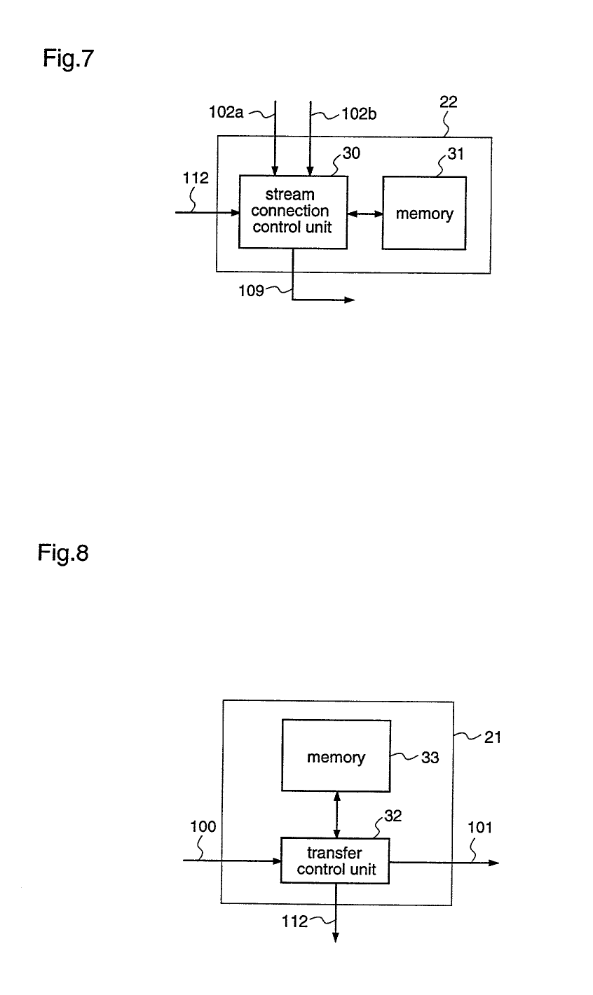

FIG. 7 is a block diagram for explaining details of the output processing unit 22 in FIG. 2.

As shown in FIG. 7, a stream connection control unit 30 receives the coded stream data 102a and 102b which are inputted from the corresponding encoding units 3, and creates continuous coded stream data 109 on the basis of the transfer control information 112 inputted from the input processing unit 21, indicating which video scene data is outputted to which encoding unit 3. A memory 31 temporarily stores the coded stream data 102a and 102b inputted from the corresponding encoding units 3.

Initially, video scene data 100 inputted into the input processing unit 21 is divided into video scene data having appropriate lengths, for example almost the same length, and divided video scene data 101 are outputted to the respective encoding units 3 (step S1001).

In the divided video scene data 101 inputted to each encoding unit 3, I picture is taken as a boundary point for carrying out the encoding process, and conditions of the encoding process for successively reproducing respective encoded data are set (step S1002). Here, the boundary point for carrying out the encoding process represents that, in the MPEG method, for example a GOP is taken as the boundary. Further, as the conditions of the encoding process for the successive reproduction, the encoding parameter information 105 transmitted from the encoder controller 1 is inputted to the motion estimation unit 10 in the encoding unit 3 shown in FIG. 3 to set a closed GOP, and further as for the code amount of each picture, the quantization information 106 transmitted from the encoder controller 1 is inputted to the quantization unit 13, thereby performing assignment of bits to each picture, so as to prevent an overflow of the buffer at the decoding, and then the encoding process is carried out. The setting of the conditions for successively reproducing the respective encoded data will be described later in more detail.

Subsequently, on the basis of the encoding conditions which are set in step S1002, the divided and outputted video scene data 101 are encoded in the first encoding unit 3a and the second encoding unit 3b, respectively (step S1003).

The coded stream data 102 which have been subjected to the encoding process are inputted to the output processing unit 22, in which the data are inputted to the stream connection control unit 30 shown in FIG. 7 and stored in the memory 31. Then, the respective coded stream data 102a and 102b are connected at the scene change point, i.e., connection boundary point, on the basis of the transfer control information 112 inputted from the input processing unit 21 (step S1004).

Here, the flowchart shown in FIG. 4 can be implemented by a computer including a CPU and a storage medium.

Now, the setting of the encoding conditions for successively reproducing the divided and inputted video scene data is described in more detail. In the embodiments of the present invention, the encoding method is the MPEG method, and video to be successively reproduced have a common frame frequency and aspect ratio.

In this embodiment, two conditions are set to successively reproduce the divided video scene data, thereby carrying out the encoding process.

Initially, since the video scene data 101 divided by the frame buffer 2 in FIG. 1 are encoded by the different encoders 3, respectively, the conditions should be set so that the respective video scene data 101 are not associated with each other. To be more specific, it is necessary to set the first GOP of the video scene data 101 as a closed GOP. Secondly, it is required that the code amount of each frame should be set so that the data buffer on the decoder side does not underflow when the coded stream data which have been separately encoded are reproduced successively.

Hereinafter, the method for setting the respective conditions will be described with reference to FIGS. 1, 3, 5 and 6.

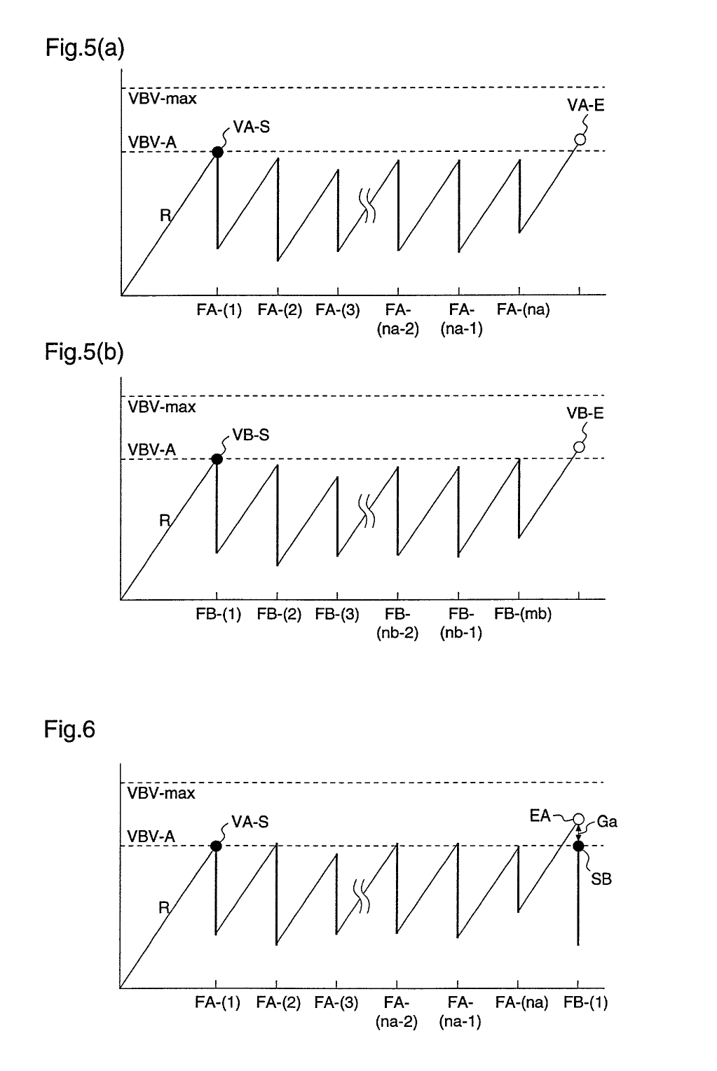

FIGS. 5 are diagrams each showing a modeled acceptable amount of coded stream data which are stored in the data buffer on the decoder side, according to the embodiments of the present invention. FIGS. 5(a) and 5(b) show coded stream data which are encoded by the two encoding units, respectively.

FIG. 6 is a diagram showing a case where the two pieces of the coded stream data in FIGS. 5 are connected with each other.

The encoder controller 1 shown in FIG. 1 includes the encoding condition setting unit 5 for setting the above-mentioned two conditions.

Initially, the encoding parameter information 105 is outputted from the encoder controller 1 into the motion estimation unit 10 included in the encoder 3. Then, the encoding parameter information 105 sets a closed GOP for the first frame among frames which are to be encoded, so that temporally forward frames are not referred to.

Then, the quantization information 106 is outputted from the encoder controller 1 into the quantization unit 13 included in the encoder 3. The quantization information 106 is a set value which is preset so that inputted encoded data are below “VBV-A” in FIG. 5. To be more specific, it represents a target code amount which is set such that as the condition for the start of encoding (VA-S) the encoding is performed so that a VBV (Video Buffering Verifier) buffer value has a predetermined value (VBV-A) shown in FIG. 5(a), and further the encoding is ended so that a value (VA-E) exceeds the predetermined value (VBV-A) also at the end of the encoding (VA-E) assuming that data are successively transferred to the buffer.

Next, the method for setting the target code amount will be described.

At the start of the encoding process for each video scene data, a quantization value is initially set in the quantization unit 13 by the encoder controller 1 as an initial value, thereby starting the encoding. Then, in the middle of the encoding process for each video scene data, the code amount at the end of the encoding for each video scene data is predicted. For example, at a time when half of video scene data have been processed, the amount of coded stream data which have been transferred to the data buffer 4 is checked by the encoder controller 1. The amount of coded stream data which are obtained when all of the video scene data have been encoded is predicted from the checked amount of coded stream data. When the predicted amount of coded stream data exceeds the target code amount, the quantization value set in the encoder 3 is changed so as to reduce coded stream data to be generated. On the other hand, when the predicted amount does not reach the target code amount, the quantization value to be set is changed so as to increase the generated coded stream data. The preset target code amount can be realized by performing this control in the middle of the encoding process.

That is, the target code amount is previously decided and thus the encoding process can be realized. There are some cases where the target code amount and the actual code amount do not completely match, but in this embodiment when the target code amount is set so that the encoding is ended at a time when the buffer value has a value exceeding VA-E or VB-E, the successive reproduction can be realized as shown in FIG. 6.

Further, when two or more pieces of coded stream data are connected, as shown in FIG. 6, a dummy stream (Ga) of a gap is arbitrarily added to a coded stream to be connected (FB-1 in FIG. 6), whereby a difference between coded stream data in the buffers can be made up.

As described above, according to the video encoding method and apparatus of the first embodiment, video scene data is divided in the time-axis direction, divided data are inputted into plural encoding units, encoding conditions are set, then the encoding process is carried out, and coded stream data which are obtained by the respective encoding units are connected with each other. Therefore, the encoding process can be carried out efficiently.

Further, the divided video scene data can be processed in parallel in the plural encoding units. Therefore, the number of parallel processings can be easily increased, whereby a flexible system structure can be constructed.

Furthermore, each encoding unit is provided with a data storage unit, whereby the parallel processing can be efficiently performed.

In this first embodiment the video encoding method and apparatus has two encoding units, while naturally it can have two or more encoding units.

Further, according to this first embodiment, in the encoding apparatus having plural encoding units, whether the input processing unit 21, the first encoding unit 3a, the second encoding unit 3b and the output processing unit 22 are constituted by difference computers, respectively, or these plural processes are implemented by one computer, similar effects can be obtained.

[Embodiment 2]

A video encoding method and apparatus according to a second embodiment of the present invention makes parts of video scene data overlap, divides the data, detects scene change points, sets encoding conditions, and carries out the encoding process.

The structure of the encoding apparatus according to the second embodiment is the same as that shown in FIGS. 2, 3 and 7 in the descriptions of the first embodiment.

FIG. 8 is a block diagram for explaining details of an input processing unit according to the second embodiment.

In FIG. 8, a transfer control unit 32 makes parts of inputted video scene data 100 overlap, divides the data, and outputs divided video scene data 101 to encoding units 3, respectively, as well as outputs transfer control information 112 indicating which video scene data is outputted to which encoding unit 3. A memory 33 temporarily stores the video scene data.

The operation of the input processing unit 21 constructed as described above will be described.

When video scene data 100 is inputted to the transfer control unit 32, video scene data 101 which has been divided first is initially outputted to the first encoding unit 3a, as well as part of the divided video scene data 101 is stored in the memory 33. Next, the transfer control unit 32 outputs video scene data 101 which has been divided second and the video scene data stored in the memory 33 to the second encoding unit 3b, as well as stores part of the second divided video scene data 101 in the memory 33. Thereafter, these operations are repeatedly performed.

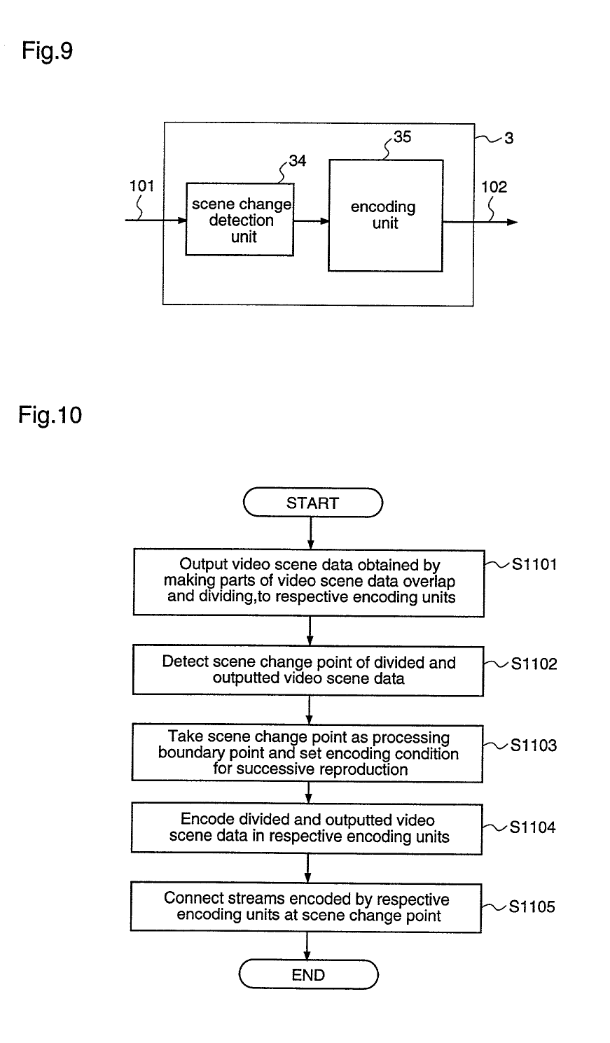

FIG. 9 is a block diagram for explaining details of the encoding unit according to the second embodiment.

In FIG. 9, a scene change detection unit 34 detects scene change points of the video scene data 101 which are divided and outputted by the input processing unit 21. Here, an encoding unit 35 has the same structure as that of the encoding unit 3 as shown in FIG. 3.

Next, the operation performed in the encoding unit 3 will be described with reference to FIGS. 2, 3 and 10.

FIG. 10 is a flowchart for explaining the operation of the encoding process according to the second embodiment.

Initially, part of video scene data 100 inputted into the input processing unit 21 and part of another video scene data are made overlap and divided, thereby obtaining video scene data 101, and the video scene data 101 are outputted to the respective encoding units 3 (step S1101).

In the divided video scene data inputted to each of the encoding units 3, scene change points are detected by the scene change detection unit 34 (step S1102).

The video scene data in which the scene change points have been detected is inputted to the encoding unit 35, the scene change point is taken as a boundary point for carrying out the encoding process, and conditions of the encoding process for successively reproducing respective encoded data are set (step S1103). Here, the boundary point for carrying out the encoding process represents that, in the case of MPEG method, for example a GOP is used as the boundary. Further, as the conditions of the encoding process for the successive reproduction, the encoding parameter information 105 transmitted from the encoder controller 1 is inputted into the motion estimation unit 10 of the encoding unit 3 shown in FIG. 3 to set a closed GOP, and further as for the code amount of each picture, the quantization information 106 transmitted from the encoder controller 1 is inputted to the quantization unit 13 so as to prevent an overflow of the buffer at the decoding, thereby performing assignment of bits in each picture, and then the encoding process is carried out. Since the details of the condition setting are described in the first embodiment, they are not described here.

Subsequently, on the basis of the encoding conditions which are set in the step S1103, the divided and outputted video scene data are subjected to the encoding process (step S1104).

The coded stream data 102 which have been subjected to the encoding process are inputted to the output processing unit 22, in which the data are inputted to the stream connection control unit 30 shown in FIG. 7 and thereafter stored in the memory 31. The stream connection control unit 30 detects the overlapped video scene part as the scene change point on the basis of the transfer control information 112 inputted from the input processing unit 21, and connects the respective coded stream data 102 with each other (step S1105).

Here, the flowchart shown in FIG. 10 can be implemented by a computer including a CPU and a storage medium.

As described above, according to the video encoding method and apparatus of the second embodiment, parts of video scene data are made overlap, the data are divided, scene change points are detected, the encoding conditions are set, then the encoding process is carried out, and coded stream data which are obtained by the respective encoding units are connected with each other. Therefore, the scene change point in the vicinity of the boundary of the divided video scene data can be detected by making the video scene data overlap, whereby the efficiency of the encoding process is improved and the higher image quality can be obtained.

Further, the divided video scene data can be processed in parallel in the plural encoding units. Therefore, the number of parallel processings can be easily increased and a flexible system structure can be constructed.

Furthermore, each encoding unit is provided with a data storage unit, whereby the parallel processing can be performed efficiently.

In this second embodiment the video encoding method and apparatus has two encoding units, while naturally it can have two or more encoding units.

Further, according to this second embodiment, in the encoding apparatus having plural encoding units, whether the input processing unit 21, the first encoding unit 3a, the second encoding unit 3b and the output processing unit 22 are constituted by different computers, respectively, or the plural processes are implemented by one computer, similar effects can be obtained.

[Embodiment 3]

A video encoding method and apparatus according to a third embodiment of the present invention detects scene change points, divides video scene data at the scene change points, sets encoding conditions, and then carries out the encoding process.

The structure of the encoding apparatus according to the third embodiment is the same as that shown in FIGS. 2, 3 and 7 in the descriptions of the first embodiment.

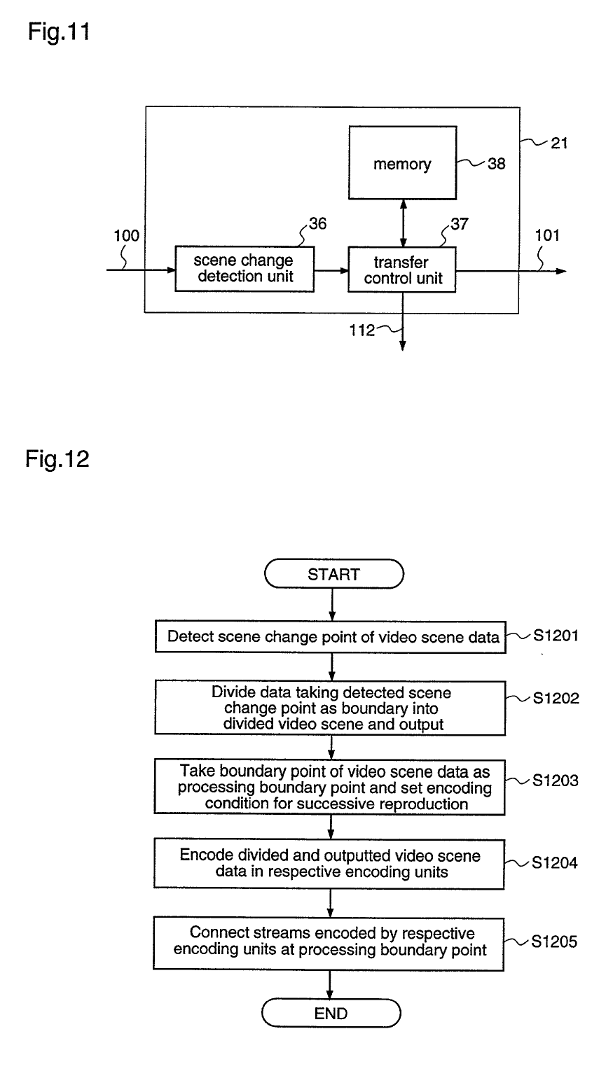

FIG. 11 is a block diagram for explaining details of an input processing unit according to the third embodiment.

In FIG. 11, a scene change detection unit 36 detects scene change points of inputted video scene data 100. A transfer control unit 37 divides the video scene data 100 on the basis of the information from the scene change detection unit 36, transfers divided video scene data 101 to the respective coding units 3 as well as outputs transfer control information 112 to the output processing unit 22. A memory 38 temporarily stores the video scene data 100.

The operation of the input processing unit 21 constructed as described above will be described.

Initially, when the scene change detection unit 36 receives the video scene data 100, it detects scene change points, and outputs the scene change point detection information and the video scene data 100 to the transfer control unit 37. The transfer control unit 37 obtains the scene change detection information while temporarily storing the inputted video scene data in the memory, and divides the video scene data taking the scene change point as the division boundary. Then, the transfer control unit 37 outputs divided video scene data 101 to the first encoding unit 3a and the second encoding unit 3b.

Next, the operation performed in the encoding unit will be described with reference to FIGS. 2, 3 and 12.

FIG. 12 is a flowchart for explaining the operation of the encoding process according to the third embodiment.

Initially, in the video scene data 100 inputted to the input processing unit 21, scene change points are detected by the scene change detection unit 36 (step S1201).

The video scene data in which the scene change points have been detected is transferred to the transfer control unit 37 and divided taking the scene change point as the boundary, and the divided video scene data are outputted to the respective encoding units 3 (step S1202).

As for the video scene data inputted to each encoding unit, the scene change point is taken as a boundary point for carrying out the encoding process, and conditions of the encoding process for successively reproducing respective encoded data are set (step S1203). Here, the boundary point for carrying out the encoding process represents that, in the case of MPEG method, for example a GOP is taken as the boundary. Further, as the conditions of the encoding process for the successive reproduction, the encoding parameter information 105 transmitted from the encoder controller 1 is inputted to the motion estimation unit 10 of the encoding unit 3 shown in FIG. 3 to set a closed GOP, and further as for the code amount for each picture, the quantization information 106 transmitted from the encoder controller 1 is inputted in the quantization unit 13 so as to prevent an overflow of the buffer at the decoding, thereby performing assignment of bits in each picture, and then the encoding process is carried out. Since the details of the setting of the conditions are described in the first embodiment, they are not described here.

Then, on the basis of the encoding conditions which are set in step S1203, the encoding process for the divided and outputted video scene data is carried out (step S1204).

The coded stream data 102 which have been subjected to the encoding process are outputted to the output processing unit 22, in which the data are inputted to the stream connection control unit 30 and thereafter stored in the memory 31. Then, on the basis of the transfer control information 112 inputted from the input processing unit 21, the respective coded stream data 102 are connected at the connection boundary point (step S1205).

The flowchart shown in FIG. 12 can be implemented by a computer including a CPU and a storage medium.

As described above, according to the video encoding method and apparatus of the third embodiment, scene change points of a video scene are detected, video scenes which are divided at the scene change points are inputted to plural encoding units, the encoding conditions are set, thereby carrying out the encoding process, and coded stream data which are obtained from the respective encoding units are connected with each other. Therefore, the efficient encoding process can be carried out.

Further, the divided video scene data can be processed in parallel in the plural encoding units. Therefore, the number of parallel processings can be easily increased, and a flexible system structure can be constructed.

Furthermore, each of the encoding units is provided with a data storage unit, whereby the parallel processing can be performed efficiently.

In this third embodiment the video encoding method and apparatus has two encoding units, while naturally it can have two or more encoding units.

Further, according to the third embodiment, in the encoding apparatus having plural encoding units, whether the input processing unit 21, the first encoding unit 3a, the second encoding unit 3b and the output processing unit 22 are constructed by difference computers, respectively, or the plural processes are implemented by one computer, similar effects can be obtained.

[Embodiment 4]

A video encoding method and apparatus according to a fourth embodiment of the present invention detects motion information including scene change points, divides video scene data so that amounts of operations in the respective encoding units are nearly equalized, sets the encoding conditions, and carries out the encoding process.

The structure of the encoding apparatus according to the fourth embodiment is the same as that shown in FIGS. 2, 3 and 7 in the descriptions of the first embodiment.

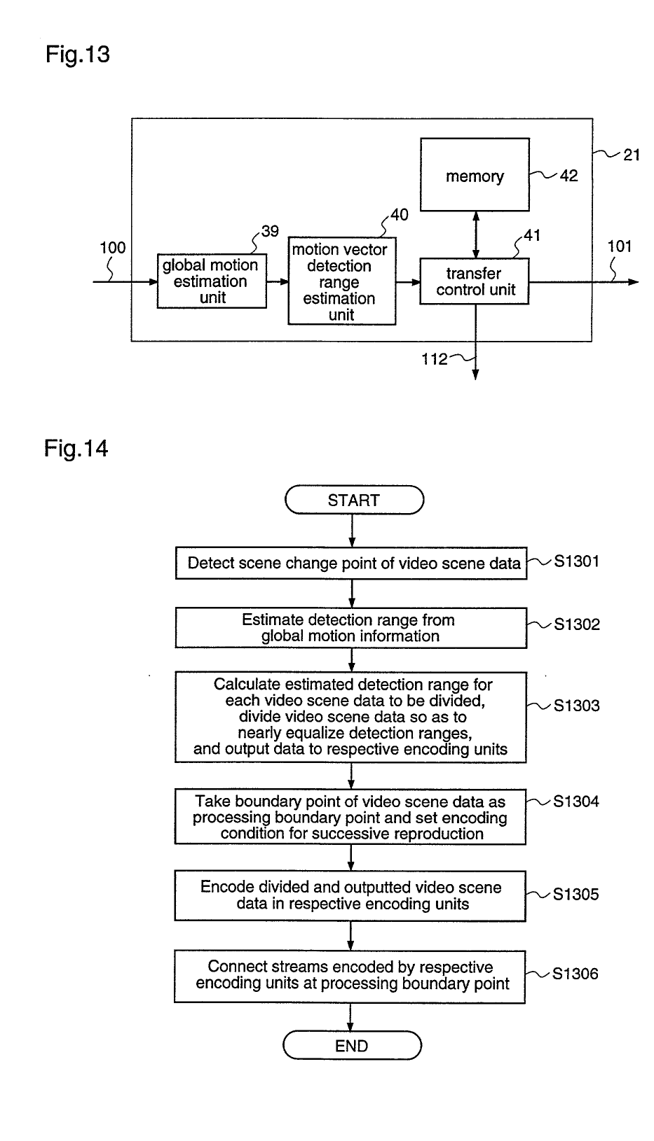

FIG. 13 is a block diagram for explaining details of an input processing unit according to the fourth embodiment.

In FIG. 13, a global motion estimation unit 39 detects motion information of inputted video scene data 100 from the video scene data 100. A motion vector detection range estimation unit 40 estimates a range of detecting a motion vector. A transfer control unit 41 estimates the amount of operation for detecting a motion vector included in divided video scene data 101 which is outputted to each encoding unit, and controls the output of the video scene data so as to nearly equalize the respective amounts of operations, as well as transmits transfer control information 112 to the output processing unit 22. A memory 42 temporarily stores the video scene data 100.

The operation of the input processing unit 21 constructed as described above will be described.

Initially, when video scene data 100 is inputted to the global motion estimation unit 39, the estimation unit 39 detects scene change points as well as detects global motion information as motion information in the video scene data, and inputs the same to the motion vector detection range estimation unit 40. The motion vector detection range estimation unit 40 provisionally decides the coding picture type on the basis of the inputted global motion information, estimates a motion vector detection range, and outputs the estimated range to the transfer control unit 41. The transfer control unit 41 temporarily stores the inputted video scene data in the memory 42 while estimating the amount of operation for detecting the motion vector information included in the video scene data on the basis of the motion vector detection range information, controls the output of video scene data so that almost equal amounts of operation are inputted to the respective encoding units 3, as well as outputs the transfer control information 112 to the output processing unit 22.

Next, the operation performed in the encoding unit will be described with reference to FIGS. 2, 3 and 14.

FIG. 14 is a flowchart for explaining the operation of the encoding process according to the fourth embodiment.

Initially, in the video scene data 100 which has been inputted to the input processing unit 21, global motion information including scene change detection points is detected by the global motion estimation unit 39 (step S1301).

The global motion information detected by the global motion estimation unit 39 is inputted to the motion vector detection range estimation unit 40, then the coding picture type and the distance from a reference picture and the like are obtained from the inputted global motion information, and a detection range required for the motion vector detection is estimated (step S1302).

Next, the detection range estimated by the motion vector detection range estimation unit 40 is obtained for each of video scene data to be divided, and the video scene data 100 is divided so that almost the same amount of operation is performed in the detection ranges included in the divided video scene data 101 inputted to the respective encoding units 3. Then, the divided video scene data 101 are outputted to the respective encoding units 3 (step S1303).

In the video scene data which has been inputted into each of the encoding units 3, the scene change point is taken as the boundary point for carrying out the encoding process, and then encoding conditions for successively reproducing respective encoded data are set (step S1304). Here, the boundary point for carrying out the encoding process represents method that, in the case of MPEG, for example a GOP is taken as the boundary. Further, as the conditions of the encoding process for the successive reproduction, the encoding parameter information 105 transmitted from the encoder controller 1 is inputted to the motion estimation unit 10 of the encoding unit 3 shown in FIG. 3 to set a closed GOP, and further as for the code amount of each picture, the quantization information 106 transmitted from the encoder controller 1 is inputted to the quantization unit 13 so as to prevent an overflow of the buffer at the decoding, thereby performing assignment of bits in each picture, and then the encoding process is carried out. Since the details of the setting of the conditions are described in the first embodiment, they are not described here.

Subsequently, on the basis of the conditions of the encoding process which are set in step S1304, the encoding process for the divided and outputted video scene data is carried out (step S1305).

The coded stream data 102 which have been subjected to the encoding process are outputted to the output processing unit 22, in which the data are inputted into the stream connection control unit 30 and thereafter stored in the memory 31. Then, on the basis of the transfer control information 112 inputted from the input processing unit 21, the respective coded stream data 102 are connected with each other at the connection boundary point (step S1306).

Here, the flowchart shown in FIG. 14 can be implemented by a computer including a CPU and a storage medium.

As described above, according to the video encoding method and apparatus of the fourth embodiment, global motion information including scene change points of a video scene is detected, the video scene data is divided so that almost the same amount of operation is performed in plural encoding units, then divided video scene data are inputted to the plural encoding units, the encoding conditions are set, thereby performing the encoding process, and coded stream data which are obtained by the respective encoding units are connected with each other. Therefore, an efficient encoding process can be carried out.

Further, the divided video scene data can be processed in parallel in the plural encoding units. Therefore, the number of parallel processings can be easily increased, and a flexible system structure can be constructed.

Furthermore, each of the encoding units is provided with a data storage unit, whereby the parallel processing can be performed efficiently.

In this fourth embodiment the video encoding method and apparatus has two encoding units, while naturally it can have two or more encoding units.

Further, according to the fourth embodiment, in the encoding apparatus having plural encoding units, whether the input processing unit 21, the first encoding unit 3a, the second encoding unit 3b and the output processing unit 22 are constructed by difference computers, respectively, or the plural processes can be implemented by one computer, similar effects can be obtained.

[Embodiment 5]

A video encoding method and apparatus according to a fifth embodiment of the present invention carries out an encoding process by using plural coding systems.

The encoding apparatus according to the fifth embodiment is the same as that shown in FIG. 2 in the description of the first embodiment.

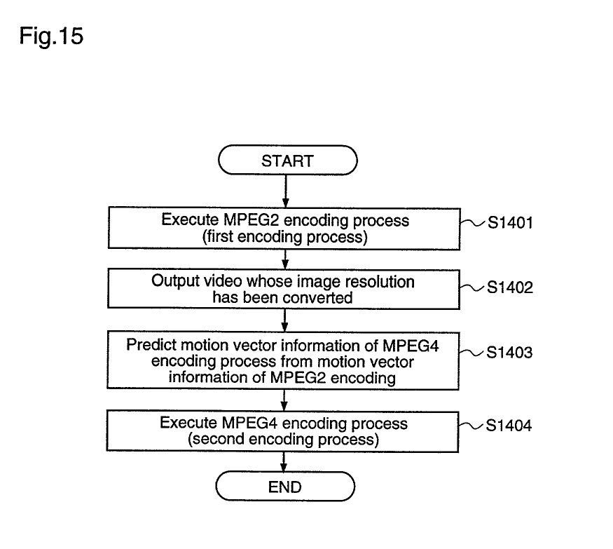

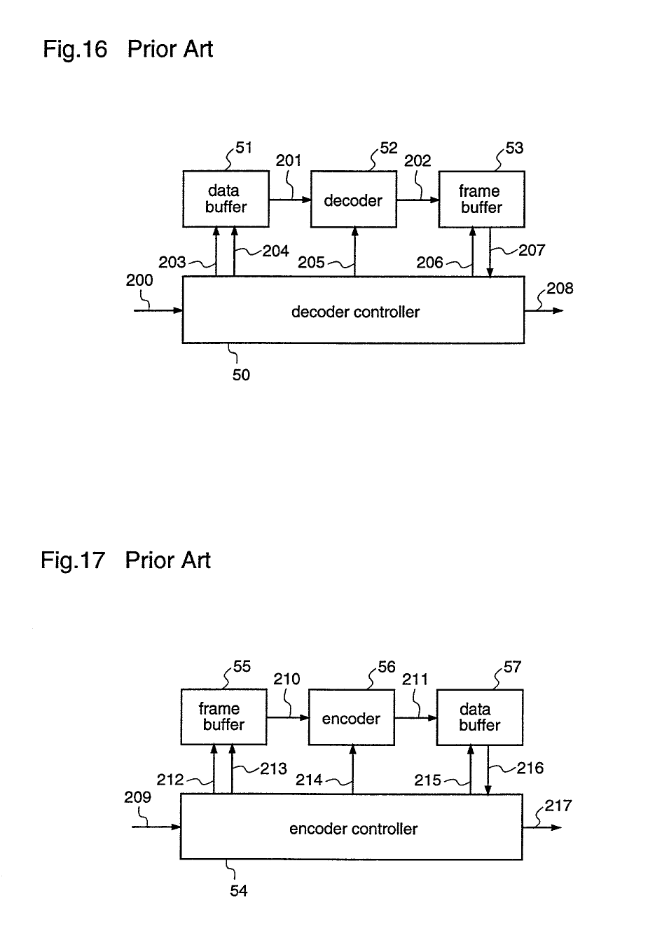

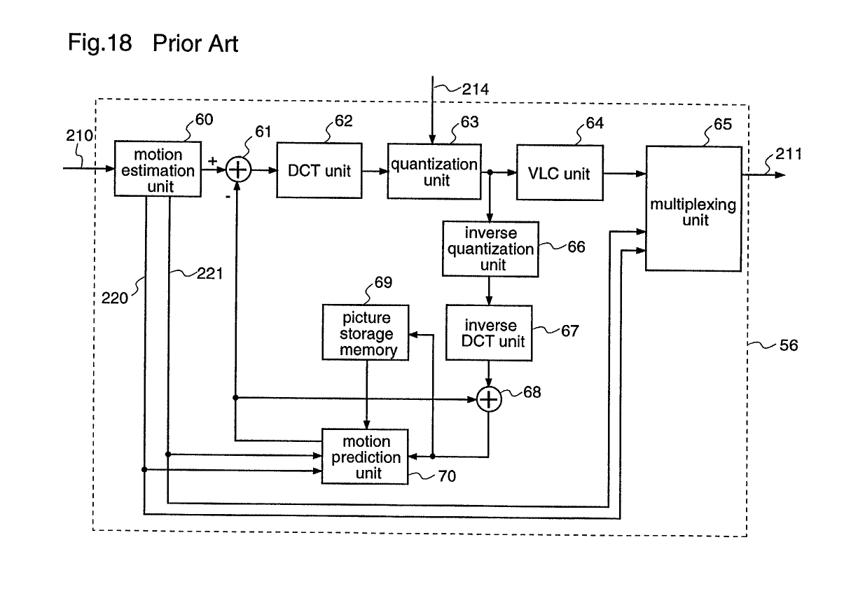

Initially, an example where an MPEG2 system is used in a first encoding process and an MPEG4 system is used in a second encoding process will be described with reference to FIG. 15.

FIG. 15 is a flowchart for explaining an operation for carrying out the encoding process by using the plural coding systems according to the fifth embodiment.

Initially, the encoding process which has been described in any of the first to fourth embodiments is carried out by using the MPEG2 system (first encoding process, step S1401). To be more specific, video scene data 100 is inputted to the encoding apparatus shown in FIG. 2, the input processing is performed in the input processing unit 21, divided video scene data 101 are encoded in respective encoding units 3 by using the MPEG2 system, and thereafter divided coded stream data 102 are connected with each other in the output processing unit 22. When this first encoding process is carried out, motion vector information in the MPEG2 encoding process can be obtained.

Subsequently, before carrying out the second encoding process, resolution is converted by the input processing unit 21, and video scene data whose resolution has been converted is inputted to each of the encoding units 3 (step S1402). The resolution conversion represents that the pixel size is reduced to about one quarter, for example.

In each of the encoding units 3, motion vector information for carrying out the MPEG4 encoding process as the second encoding process is predicted on the basis of the motion vector information obtained in the MPEG2 encoding process as the first encoding process (step S1403).

Then, with using the motion vector information obtained in step S1403, the MPEG4 encoding process is carried out (second encoding process, step S1404).

As described above, according to the video encoding method and apparatus of the fifth embodiment, the encoding process is carried out with using plural encoding systems. Therefore, by using the result of the first encoding system, the operation according to the second and subsequent encoding systems can be partly omitted, whereby the encoding process by the plural encoding systems can be performed efficiently.

In this fifth embodiment, the MPEG2 system is used as the first encoding system, while the MPEG4 system can be used. To be more specific, for example resolution conversion is performed by using a result of the MPEG4 encoding system at the first time, whereby operations of the MPEG4 encoding system of the second and subsequent times can be partly omitted. Further, the MPEG4 system is used as the second encoding system, while the MPEG2 system can be used. To be more specific, for example resolution conversion is performed by using a result of the MPEG2 system at the first time, whereby operations of the MPEG2 system of the second and subsequent time scan be partly omitted. As apparent from the above descriptions, it goes without saying that similar effects can be obtained even when the first encoding system is implemented by the MPEG4 system and the second encoding system is implemented by the MPEG2 system.

Further, according to the fifth embodiment, in the encoding apparatus having plural encoding units, whether the input processing unit 21, the first encoding unit 3a, the second encoding unit 3b and the output processing unit 22 are constructed by different computers, respectively, or the plural processes are implemented by one computer, similar effects can be obtained.

What is claimed is:

1. A video encoding method for carrying out an encoding process in a video encoding apparatus having plural encoding units comprising steps of:
dividing video scene data into plural pieces;
setting encoding conditions for the divided video scene data to decode an end point of a divided video scene and a start point of a following divided video scene data successively when these consecutive video scene data are connected with each other;
inputting the divided video scene data into the plural encoding units and creating coded stream data; and
connecting the coded stream data obtained from the plural encoding units with each other.

2. The video encoding method of claim 1 wherein
the setting of the encoding conditions includes at least:
setting of a closed GOP, which is performed for the start point of the divided video scene data; and
setting of a target amount of codes, which is performed for the encoding units, such that an amount of data occupying a buffer memory has a predetermined value when the coded stream data are successively decoded.

3. A video encoding method for carrying out an encoding process in a video encoding apparatus having plural encoding units comprising steps of:
making parts of video scene data overlap and dividing the video scene data;
detecting scene change points of the divided video scene data;
setting encoding conditions for the divided video scene data to decode the scene change points of consecutive video scene data successively when these consecutive video scene data are connected with each other;
inputting the divided video scene data into the plural encoding units and creating coded stream data; and
connecting the coded stream data obtained from the plural encoding units with each other.

4. The video encoding method of claim 3 wherein
the setting of the encoding conditions include at least:
setting of a closed GOP, which is performed for a start point of the divided video scene data; and
setting of a target amount of codes, which is performed for the encoding units, such that an amount of data occupying a buffer memory has a predetermined value when the coded stream data are successively decoded.

5. A video encoding method for carrying out an encoding process in a video encoding apparatus having plural encoding units comprising steps of:
detecting scene change points of video scene data;
dividing the video scene data at the scene change points;
setting encoding conditions for the divided video scene data to decode an end point of a divided video scene data and a start point of a following divided video scene data successively when these consecutive video scene data are connected with each other;
inputting the divided video scene data into the plural encoding units and creating coded stream data; and
connecting the coded stream data obtained from the plural encoding units with each other.

6. The video encoding method of claim 5 wherein
the setting of the encoding conditions includes at least:
setting of a closed GOP, which is performed to the start point of the divided video scene data; and
setting of a target amount of codes, which is performed for the encoding units, such that an amount of data occupying a buffer memory has a predetermined value when the coded stream data are successively decoded.

7. A video encoding method for carrying out an encoding process in a video encoding apparatus having plural encoding units comprising steps of:
detecting scene change points of video scene data;
detecting motion information in the video scene data;
dividing the video scene data so that amounts of operations in the plural encoding units are nearly equalized;
setting encoding conditions for the divided video scene data to decode an end point of a divided video scene data and a start point of a following divided video scene data successively when these consecutive video scene data are connected with each other;
inputting the divided video scene data into the plural encoding units and creating coded stream data; and
connecting the coded stream data obtained from the plural encoding units with each other.

8. The video encoding method of claim 7 wherein
the setting of the encoding conditions include at least:
setting of a closed GOP, which is performed for the start point of the divided video scene data; and
setting of a target amount of codes, which is performed for the encoding units, such that an amount of data occupying a buffer memory has a predetermined value when the coded stream data are successively decoded.

9. The video encoding method of claim 7 wherein
the division of the video scene data is performed so as to nearly equalize detection ranges of motion vectors for encoding the video scene data.

10. A video encoding method for carrying out an encoding process by plural encoding systems comprising steps of:
carrying out an encoding process by a first encoding system; and
carrying out an encoding process by a second encoding system with using an encoding result obtained by the first encoding system.

11. The video encoding method of claim 10 wherein
the encoding result obtained by the first encoding system is motion vector detection information.

12. The video encoding method of claim 10 wherein
the first encoding system is an MPEG2 or MPEG4 system, and
the second encoding system is an MPEG4 or MPEG2 system.

13. A video encoding apparatus having plural encoding units comprising:
a division unit for dividing video scene data;
an encoding condition setting unit for setting encoding conditions for the divided video scene data to decode an end point of a divided video scene data and a start point of a following divided video scene data successively when these consecutive video scene data are connected with each other;
plural encoding units for encoding the divided video scene data to create coded stream data; and
a connection unit for connecting the coded stream data obtained from the plural encoding units with each other.

14. The video encoding apparatus of claim 13 wherein
the encoding condition setting unit performs at least:
setting of a closed GOP, which is performed for the start point of the divided video scene data; and
setting of a target amount of codes, which is performed for the encoding units, such that an amount of data occupying a buffer memory has a predetermined value when the coded stream data are successively decoded.

15. A video encoding apparatus having plural encoding units comprising:
a division unit for making parts of video scene data overlap and dividing the video scene data;
a scene change point detection unit for detecting scene change points of the divided video scene data;
an encoding condition setting unit for setting encoding conditions for the divided video scene data to decode the scene change points of consecutive video scene data successively when these consecutive video scene data are connected with each other;
plural encoding units for encoding the divided video scene data to create coded stream data; and
a connection units for connecting the coded stream data obtained from the plural encoding units with each other.

16. The video encoding apparatus of claim 15 wherein
the encoding condition setting unit performs at least:
setting of a closed GOP, which is performed for a start point of the divided video scene data; and
setting of a target amount of codes, which is performed for the encoding units, such that an amount of data occupying a buffer memory has a predetermined value when the coded stream data are successively decoded.

17. A video encoding apparatus having plural encoding units comprising:
a scene change detection unit for detecting scene change points of video scene data;
a division unit for dividing the video scene data at the scene change points;
an encoding condition setting unit for setting encoding conditions for the divided video scene data to decode an end point of a divided video scene data and a start point of a following divided video scene data successively when these consecutive video scene data are connected with each other;
plural encoding units for encoding the divided video scene data to create coded stream data; and
a connection unit for connecting the coded stream data obtained from the plural encoding units with each other.

18. The video encoding apparatus of claim 17 wherein
the encoding condition setting unit performs at least:
setting of a closed GOP, which is performed for the start point of the divided video scene data; and
setting of a target amount of codes, which is performed for the encoding units, such that an amount of data occupying a buffer memory has a predetermined value when the coded stream data are successively decoded.

19. A video encoding apparatus having plural encoding units comprising:
a scene change point detection unit for detecting scene change points of video scene data;
a motion information detection unit for detecting motion information in the video scene data;
a division unit for dividing the video scene data so that amounts of operations in the plural encoding units are nearly equalized;
an encoding condition setting unit for setting encoding conditions for the divided video scene data to decode an end point of a divided video scene data and a start point of a following divided video scene data successively when these consecutive video scene data are connected with each other;
plural encoding units for encoding the divided video scene data to create coded stream data; and
a connection unit for connecting the coded stream data obtained from the plural encoding units with each other.

20. The video encoding apparatus of claim 19 wherein
the encoding condition setting unit performs at least:
setting of a closed GOP, which is performed for the start point of the divided video scene data; and
setting of a target amount of code, which is performed for the encoding units, such that an amount of data occupying a buffer memory has a predetermined value when the coded stream data are successively decoded.

21. The video encoding apparatus of claim 19 wherein
the division unit divides the video scene data such that detection ranges of motion vectors for encoding the video scene data are nearly equalized.

22. A video encoding apparatus for carrying out an encoding process by plural encoding systems comprising:
a first encoding unit for carrying out an encoding process by a first encoding system; and
a second encoding unit for carrying out an encoding process by a second encoding system with using an encoding result obtained by the first encoding system.

23. The video encoding apparatus of claim 22 wherein
the result obtained by the first encoding system is motion vector detection information.

24. The video encoding apparatus of claim 22 wherein
the first encoding unit uses an MPEG2 or MPEG4 system, and
the second encoding unit uses an MEPG4 or MPEG2 system.
